(19) United States
(12) Patent Application Publication
(10) Pub. No.: US 2024/0238794 A1
(43) Pub. Date: Jul. 18, 2024

(54) PULVERIZATION POT STRUCTURE OF KITCHEN WASTE PULVERIZATION APPARATUS

(71) Applicant: Ling-Feng Chen, Taipei City (TW)

(72) Inventor: Ling-Feng Chen, Taipei City (TW)

(21) Appl. No.: 18/406,213

(22) Filed: Jan. 8, 2024

(30) Foreign Application Priority Data
Jan. 17, 2023 (CN) 202320136192.3

(51) Int. Cl. B02C 17/16

(52) U.S. Cl. CPC B02C 17/163

(57) ABSTRACT

A pulverization pot structure is provided for a kitchen waste pulverization apparatus and includes a pulverization pot, a stirrer mechanism, and two cutter holder mechanisms. The stirrer mechanism is arranged in the pulverization pot and driven by a pre-arranged drive motor device to rotate. The two cutter holder mechanisms are movably arranged in the pulverization pot and each includes a cutter holder having a plurality of mounting portions arranged in a stepped form and each receiving a cutter to fasten thereto. The cutter holder is connected to a connection arm, which is fit, in a removable manner, in the pulverization pot. Lifting upward the connection arms connected to the cutter holders can simultaneously detach and remove the cutter holders out of the pulverization pot, and loosening the fastener elements of the cutters allows the cutters to be removed from the mounting portions of the cutter holders.

### BACKGROUND OF THE INVENTION

### (a) Technical Field of the Invention

The present invention relates to a pulverization pot structure of a kitchen waste pulverization apparatus, and more particularly to one that comprises an arrangement in which a cutter holder is connected to a connection arm and the connection arm is fit to a circumference of an opening of a pulverization pot in a movable manner so that lifting upward the connection arm simultaneously removes the cutter holder out of the pulverization pot; and the cutter holder comprises a plurality of mounting portions arranged in a stepped form to respectively receive cutters to fasten thereto so that loosening fastener elements of the cutters allows the cutters to be removed from the mounting portions of the cutter holder, so that an effect is achieved with respect to the cutter holder and the cutters arranged in the pulverization pot being efficiently and easily detached and removed for cleaning to thereby enhance replacement of the cutters and easy cleaning of bacteria breeding and bad smell resulting from contaminants hidden in the cutter holder and the cutters.

### (b) Description of the Prior Art

In washing dishware, minor food wastes remaining on dishes and bowls are commonly flushed away by water to flow into a sink of a kitchen countertop and will flow through the sink of the kitchen countertop to get deposited in the drainage pipe. The drainage pipe system will then get jammed by the kitchen waste and food residues after a long period of such deposition. The worst thing is that odor will generate through fermentation of such wastes and will easily spread over the entire house.

Handling the kitchen waste remaining from all sort of cooking processes is not easy and is one of the major concerns of the general housewives. The kitchen wastes, if not immediately placed in a kitchen waste bin, which is generally placed outdoors, will be temporarily kept indoors. This leads to deposition of kitchen wastes, and thus fermentation and spreading of bad smell. In the worst case, bacteria, flies, cockroaches, and mice may get breeding. This surely affects the living quality and body healthy.

To resolve the issue of inconvenient processing of kitchen waste, manufacturers have developed various kinds of kitchen waste processing apparatus, among which a known kitchen waste processing apparatus featuring environmental protection function is structured to first pulverize the kitchen waste and then add therein wood chips and enzymes to convert, after being kept for days, into reusable liquid fertilizer, so as to fulfill a kitchen waste reuse based environmental protection function. Further, another known kitchen waste processing apparatus featuring environmental protection function is structured to pulverize the kitchen waste and drying for an extended period of time to convert the kitchen waste into reusable solid fertilizer, so as to fulfill a kitchen waste reuse based environmental protection function. Further, another commonly known type of kitchen waste processing apparatus is structured to primarily pulverize the kitchen waste to be combined with a water flow for draining into the drainage pipe of the sink of the kitchen countertop for conveying into a public sewage system.

All these known types of kitchen waste processing apparatus rely on a cutting blade arranged in an interior of an internal pot of the kitchen waste processing apparatus to implement an operation of chopping and shredding (pulverizing) the kitchen waste. However, the cutting blade arranged in the internal pot of the known kitchen waste processing apparatus is generally of a fixed arrangement that does not allow self-removal. After an extended period of use, a cutter holder and the cutting blade would get a certain amount of chopped kitchen waste attached thereon, and this similarly leads to the previously discussed situations of bacterium breeding and bad smell. Further, after the cutting blade wears out, servicing and replacing are difficult problems for subsequent uses.

### SUMMARY OF THE INVENTION

The present invention discloses a pulverization pot structure of a kitchen waste pulverization apparatus, and more particularly one that is connectable with a drive motor device that is already existing in a kitchen waste pulverization apparatus. The pulverization pot structure comprises a pulverization pot, a stirrer mechanism, and at least two cutter holder mechanisms. The pulverization pot is formed, in an interior thereof, with a receiving space and has an opening including a circumference from which a protruding rim protrudes outwards. At least two positioning portions in the form of notches are formed in the protruding rim. An axle hole portion is arranged in the receiving space of the pulverization pot. The stirrer mechanism is arranged on the axle hole portion in the interior of the pulverization pot. The stirrer mechanism is connectable with the drive motor device so that the drive motor device drives the stirrer mechanism to rotate. Further, the two cutter holder mechanisms are separately arranged, in a movable manner, in the receiving space of the pulverization pot. The cutter holder mechanisms comprise a cutter holder and a connection arm. The cutter holder has a surface facing the receiving space and formed with a plurality of mounting portions, and the plurality of mounting portions are arranged in a stepped form. Each of the mounting portions is formed with a mounting surface, and the mounting surface receives a cutter to fix thereto. Further, the connection arm has one end fixed to the cutter holder and an opposite end formed with a retaining portion, and the retaining portion is fit to and retained in the positioning portion of the pulverization pot.

Technical features of the present invention are that the cutter holders are combined with the connection arms, and the connection arms are fit to and retained in the positioning portions formed in the circumference of the opening of the pulverization pot to thereby arrange the cutter holders in a movable manner in the pulverization pot, wherein lifting upward the connection arms simultaneously remove the cutter holders out of the pulverization pot; and the plurality of mounting portions of the cutter holders, which are arranged in a stepped form, respectively receive cutters to mount thereto, and loosening the fastener elements from the cutters allows the cutters to be removed from the mounting portions of the cutter holders. As such, the cutter holders and the cutters arranged in the interior of the pulverization pot can be efficiently and easily detached for removal to achieve efficacy of servicing, replacing, and maintaining and avoid issues of bacterium breeding and bad smell caused by contaminants hidden in the cutter holders and the cutters. And, also, the cutter holders and the cutters can be efficiently and easily detached and removed out so that a servicing operator may easily carry out an operation of service, replacement, or maintenance for the cutter holders and the cutters.

### BRIEF DESCRIPTION OF THE DRAWINGS

FIG. 1 is a schematic view, in a partly exploded form, showing a pulverization pot structure according to the present invention.

FIG. 2 is an exploded view showing a cutter holder mechanism of the pulverization pot structure according to the present invention.

FIG. 3 is an exploded view showing a stirrer mechanism of the pulverization pot structure according to the present invention.

FIG. 4 is a side elevational view, in a sectioned form, showing the pulverization pot structure according to the present invention.

### DETAILED DESCRIPTION OF THE PREFERRED EMBODIMENTS

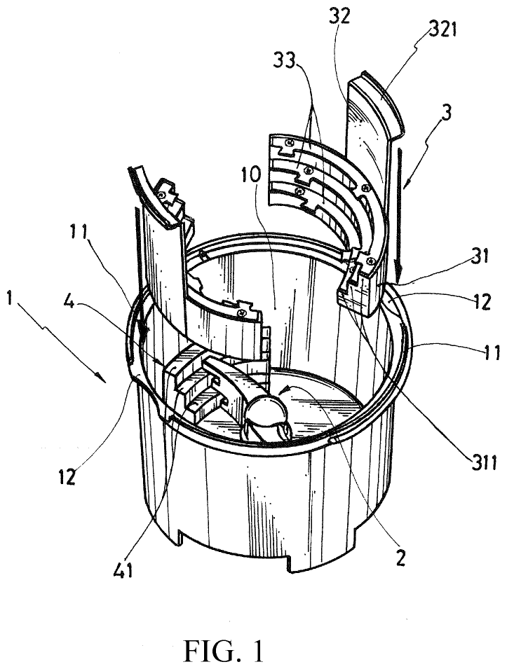

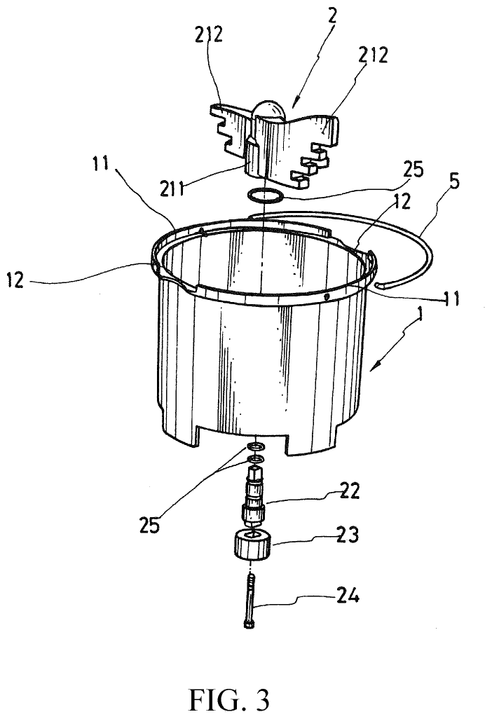

Referring to FIGS. 1-4, the present invention provides a pulverization pot structure of a kitchen waste pulverization apparatus, which is particularly connectable with a drive motor device arranged in the kitchen waste pulverization apparatus. The pulverization pot structure according to the present invention comprises a pulverization pot 1, a stirrer mechanism 2, at least two cutter holder mechanisms 3, and at least one stop block 4.

The pulverization pot 1 is formed, in an interior thereof, with a receiving space 10 having an opening that has a circumference from which a protruding rim 11 protrudes. The pulverization pot 1 comprises at least two positioning portions 12, each in the form of a notch, arranged at positions corresponding to the protruding rim 11, and the pulverization pot 1 is provided, in a bottom of the receiving space 10, with an axle hole portion 13. The axle hole portion 13 is in the form of a protruding hollowed pillar. The pulverization pot 1 is connected, at the opening thereof, to a lifting handle 5.

The stirrer mechanism 2 is arranged on the axle hole portion 13 in the interior of the pulverization pot 1. The stirrer mechanism 2 is connectable, in a rotatable manner, to a drive motor device of the kitchen waste pulverization apparatus so that the drive motor device drives the stirrer mechanism 2 to rotate. The stirrer mechanism 2 comprises a stirring member 21, a drive axle 22, and a rotation ring 23. The stirring member 21 comprises a center axle portion 211 and at least two plates 212 extending outward from a center defined by the center axle portion 211. The center axle portion 211 is fit to and combinable with the axle hole portion 13 of the pulverization pot 1. The drive axle 22 extends through the axle hole portion 13 of the pulverization pot 1 and is received in an interior of the center axle portion 211. The rotation ring 23 is arranged outside of the pulverization pot 1 and is set at a location of a bottom of the drive axle 22. A fastening member 24 (such as a bolt) sequentially penetrates through and fastens together the rotation ring 23, the drive axle, 22 and the center axle portion 211, so that the rotation ring 23, the drive axle 22, and the center axle portion 211 demonstrate a function of synchronous rotation, wherein a spindle of the drive motor device is connected, in a rotatable manner, to the rotation ring 23 to enable the drive motor device to drive the stirrer mechanism 2 to rotate. The drive axle 22 further receives a plurality of seal rings 25 fit thereto for sealing to prevent liquid in the interior of the pulverization pot 1 from flowing out through the axle hole portion 13.

The at least two cutter holder mechanisms 3 are movably arranged in the receiving space 10 of the pulverization pot 1. The cutter holder mechanisms 3 each comprise a cutter holder 31 and a connection arm 32. The cutter holder 31 has a surface facing the receiving space 10 and including a plurality of mounting portions 311. The plurality of mounting portions 311 are arranged in a stepped form, and each of the mounting portions 311 has a top surface forming a mounting surface 312, and the mounting surface 312 receives a cutter 33 fixed thereto through fastening. The connection arm 32 has one end fixedly connected to the cutter holder 31 and an opposite end formed with a retaining portion 321. The retaining portion 321 is in a curved form or a hook form. The retaining portion 321 is fit into a corresponding one of the positioning portions 12 of the pulverization pot 1, such that interference is established between the retaining portion 321 and the positioning portion 12 in a horizontal direction to securely fix the cutter holder 31 in the pulverization pot 1, while allowing the cutter holder 31 to be removed as being vertically lifted by means of the connection arm 32.

The stop block 4 is fixedly mounted in the receiving space 10 of the pulverization pot 1 and is arranged to stagger with respect to the cutter holders 31. The stop block 4 has a surface facing the receiving space 10 and forming a working surface 41, and the working surface 41 is arranged in a stepped form.

The plates 212 of the stirring member 21 each have an end that is structured in a stepped form, such that the stepped forms of the ends of the plates 212 correspond, in an opposite direction, to the mounting portions 311 of the cutter holders 31 and the working surfaces 41 of the stop block 4, wherein the ends of the plates 212 are set in a staggered form with respect to the mounting portions 311 of the cutter holder 31 and the working surface 41 of the stop block 4.

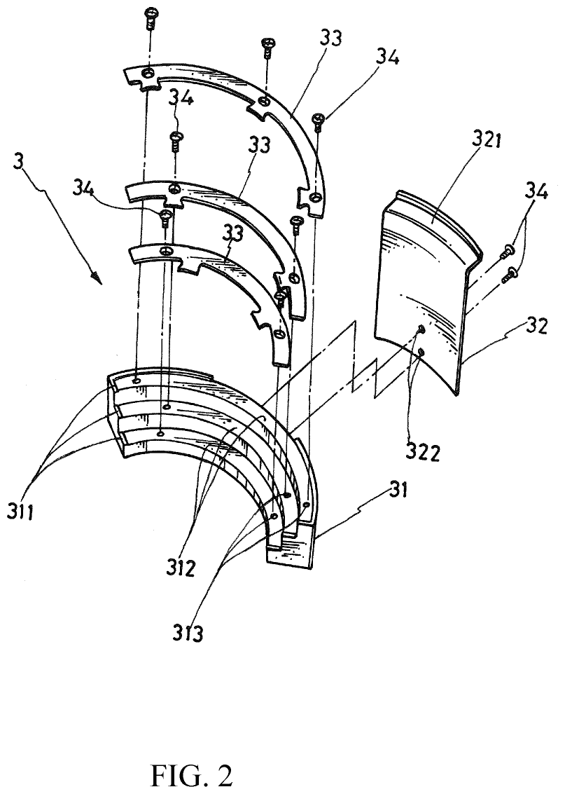

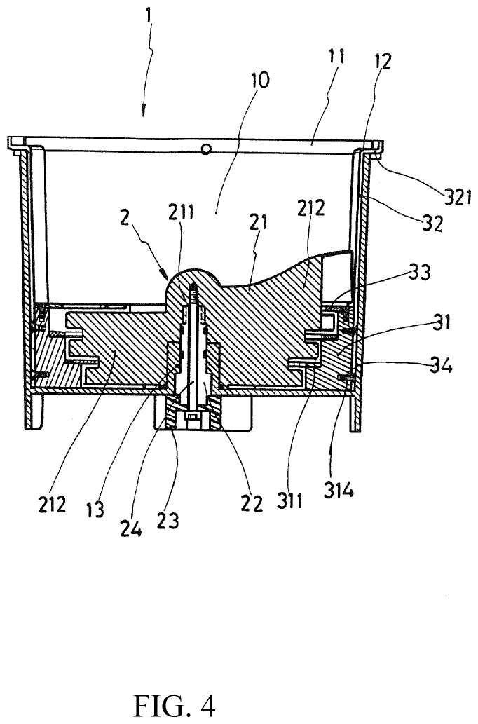

Referring to FIGS. 2 and 4, the cutter holders 31 each include a plurality of first fastening apertures 313 formed in the mounting surfaces 312, a plurality of second fastening apertures 314 formed in a back of the cutter holder 3, and a plurality of third fastening apertures 322 formed in the connection arm 32. A plurality of fastener elements 34 are applied to fasten in through holes formed in the cutters 33 and the first fastening apertures 313 to fix the cutters 33 to the mounting portions 311; and a plurality of additional fastener elements 34 are applied to fasten the third fastening apertures 322 and the second fastening apertures 314 to fix the connection arm 32 to the cutter holder 31.

In summary, the features of the present invention are that the cutter holder 31 is combined with the connection arm 32, and the connection arm 32 is fit to and retained in the positioning portion 12 formed in the edge of the opening of the pulverization pot 1 to thereby arrange the cutter holder 31 in a movable manner in the pulverization pot 1, and vertically lifting up the connection arm 32 simultaneously brings the cutter holder 31 up to withdraw out of the pulverization pot 1; and the plurality of mounting portions 311 of the cutter holder 31, which are arranged in a stepped form, respectively receive the cutters 33 to mount thereto and loosening the fastener elements 34 from the cutters 33 allows the cutters 33 to be detached from and removed from the mounting portions 311 of the cutter holder 31; and as such, the cutter holder 31 and the cutters 33 that are arranged in the interior of the pulverization pot 1 can be efficiently and easily removed out through the movable arrangement for separating and cleaning to thereby avoid bacterium breeding and bad smell due to contaminant hidden in the cutter holder 31 and the cutters 33.

Further, the cutter holder 31 is arranged such that the cutter 33 can be easily removed out of the pulverization pot 1 to allow a servicing operator to easily carry out an operation of service, replacement, and maintenance for the cutter holder 31 and the cutters 33.

I claim:

1. A pulverization pot structure of a kitchen waste pulverization apparatus, which is adapted to connect with a drive motor device of the kitchen waste pulverization apparatus, the pulverization pot structure comprising:
a pulverization pot, which is formed with a receiving space, the pulverization pot having an opening including a circumference from which a protruding rim protrudes outward, at least two positioning portions in the form of notches formed in the protruding rim, an axle hole portion being arranged in an interior of the pulverization pot;
a stirrer mechanism, which is arranged on the axle hole portion in the interior of the pulverization pot, the stirrer mechanism being connectable with the drive motor device so that the drive motor device drives the stirrer mechanism to rotate; and
at least two cutter holder mechanisms, which are arranged, in a movable manner, in the receiving space of the pulverization pot, the cutter holder mechanisms each comprising a cutter holder and a connection arm, the cutter holder having a surface facing the receiving space and formed with a plurality of mounting portions, the mounting portions being arranged in a stepped form, wherein each of the mounting portions comprises a mounting surface and the mounting surface receives a cutter fixedly mounted thereto, the connection arm having one end fixed to the cutter holder and an opposite end formed with a retaining portion, the retaining portion being fit to and retained in a corresponding one of the positioning portions of the pulverization pot;
wherein the cutter holder is liftable upward by means of the connection arm to be removed out of the pulverization pot.

2. The pulverization pot structure of the kitchen waste pulverization apparatus according to claim 1, wherein the plurality of mounting surfaces are each formed with a plurality of first fastening apertures; a back of the cutter holder is formed with a plurality of second fastening apertures; the connection arm is formed with a plurality of third fastening apertures, wherein a plurality of fastener elements are applied to fasten through holes formed in the cutters and the first fastening apertures to fasten the cutters to the mounting portions, and a plurality of fastener elements are applied to fasten the third fastening apertures and the second fastening apertures to fasten the connection arm to the cutter holder.

3. The pulverization pot structure of the kitchen waste pulverization apparatus according to claim 1, wherein at least one stop block is provided such that the stop block is fixedly mounted in the receiving space of the pulverization pot and is arranged to stagger with respect to the cutter holder, and the stop block has a surface facing the receiving space and forming a working surface, the working surface being arranged in a stepped form.

4. The pulverization pot structure of the kitchen waste pulverization apparatus according to claim 3, wherein the stirrer mechanism comprises a stirring member, a drive axle, and a rotation ring, wherein the stirring member comprises a center axle portion and at least two plates extending outward from a center defined by the center axle portion, and the center axle portion is arranged on and combinable with the axle hole portion of the pulverization pot, the drive axle extending through the axle hole portion of the pulverization pot and received in the center axle portion, the rotation ring arranged outside of the pulverization pot and set at a bottom of the drive axle, a fastening member penetrating sequentially through and fastening the rotation ring, the drive axle, and the center axle portion to form a mechanism of synchronous rotation among the rotation ring, the drive axle, and the center axle portion.

5. The pulverization pot structure of the kitchen waste pulverization apparatus according to claim 4, wherein the rotation ring is connected to a spindle of the drive motor device, so that the drive motor device drives the stirrer mechanism to rotate.

6. The pulverization pot structure of the kitchen waste pulverization apparatus according to claim 4, wherein the drive axle comprises a plurality of seal rings fit thereto.

7. The pulverization pot structure of the kitchen waste pulverization apparatus according to claim 4, wherein the plates extending outward from the center axle portion of the stirring member are structured such that an end of each of the plates is made in a stepped form, and the stepped form of the end of the plate is corresponding, in an opposite direction, to the mounting portions of the cutter holders and the working surface of the stop block, wherein the ends of the plates are set in a staggered form with respect to the mounting portions of the cutter holders and the working surface of the stop block.
